(19) United States
(12) Patent Application Publication
(10) Pub. No.: US 2008/0091524 A1
(43) Pub. Date: Apr. 17, 2008

(54) System and method for advertisement price adjustment utilizing traffic quality data

(75) Inventors: Tak W. Yan, Palo Alto, CA (US); Kerem Tomak, Mountain View, CA (US); Chi-Chao Chang, Santa Clara, CA (US)

Correspondence Address: YAHOO! INC.;C/O DREIER LLP, 499 PARK AVENUE, NEW YORK, NY, 10022, US

(73) Assignee: Yahoo! Inc., Sunnyvale, CA (US)

(21) Appl. No.: 11/580,586

(22) Filed: Oct. 13, 2006

(51) Int. Cl. G06Q 30/00

(52) U.S. Cl. 705/14

(57) ABSTRACT

The present invention relates to systems and methods for generating an adjustment factor for a cost associated with a user selection of an advertisement displayed at a website. The method of the present invention comprises retrieving analytics data and traffic quality metric data associated with the website, and calculating a traffic quality score for the website. An adjustment factor for the website is calculated based upon the traffic quality score associated with the website and a benchmark traffic quality score.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to the distribution of advertisements to one or more websites. More specifically, the invention relates to the calculation of an adjustment factor for a cost associated with an advertisement displayed or selected at a given website based upon the traffic quality of the given website.

### BACKGROUND OF THE INVENTION

Advertisements are commonly used on the Internet to promote various products and services. Advertisements may comprise banner ads, links to web pages, images, video, text, etc. The various advertisements used to promote products on the Internet may be displayed according to a variety of formats, such as in conjunction with a ranked result set in response to a query, embedded in a web page, a pop-up, etc. The advertisements displayed to a user of a client device may be selected, redirecting the user to a website providing the advertised product or service. An advertiser associated with an advertisement displayed to or selected by a user of a client device typically incurs a charge for the display or user selection of the advertisement in order to compensate the website responsible for displaying the advertisement.

Users of client devices, communicatively coupled to a network, such as the Internet, are capable of accessing various websites that may display advertisements. Websites visited by users of client devices that display advertisements may range from very popular and frequently visited websites to smaller websites, such as individual blogs, that receive significantly less user traffic. To an advertiser, the value of a user selection of an advertisement displayed at a website may be based upon several factors, such as whether the user selection ultimately leads to a conversion of an advertised product or service, or the duration of time a user remains on an advertiser's website after selection of an advertisement. Whether a user selection of an advertisement results in a conversion, or the duration of time a user remains on an advertiser's website, may be attributable to the traffic quality of a given website.

The traffic quality of a given website may be based upon several factors, such as the quality of the content displayed at the website, the popularity of the website, the appeal of the website to users, or the way in which content, including advertisements, are displayed to users. For example, user selections of advertisements displayed at a popular and frequently visited website may result in significantly more conversions than user selections of advertisements displayed at a given blog.

A user selection of an advertisement displayed at a given website typically results in the advertiser associated with the advertisement incurring a charge for the user selection, which may also include a user impression of an advertisement. As previously described, however, the frequency with which a user selection of an advertisement results in a conversion may be attributable to the traffic quality of the website displaying the advertisement. Therefore, the value of a user selection of an advertisement displayed at a website with good traffic quality is of greater value than a user selection of an advertisement displayed at a website with poor traffic quality.

Existing techniques for charging advertisers for the display of advertisements or one or more user selections of advertisements displayed at a website simply utilize the frequency with which advertisements associated with a given advertiser are displayed or selected in order to calculate a cost for the advertiser, regardless of the website at which the advertisements are displayed. Therefore, existing techniques fail to provide advertisers with an appropriate adjustment factor to a cost associated with the display or a user selection of an advertisement based upon the value an advertiser receives from a given user selection. In order to overcome shortcomings associated with existing techniques for charging advertisers for the display of advertisements or one or more user selections of advertisements, the present invention provides systems and methods for calculating an adjustment factor for a cost associated with the display of advertisements or one or more user selections of advertisements displayed at a website.

### SUMMARY OF THE INVENTION

The present invention is directed towards methods and systems for generating an adjustment factor for a cost associated with a user selection of an advertisement displayed at a website. The method of the present invention comprises retrieving analytics data and traffic quality metric data associated with the website. The analytics data associated with the website may comprise data indicating a frequency with which one or more advertisements displayed at the website are selected and a frequency with which one or more conversion result from one or more user selections of advertisements displayed at the website. The traffic quality metric data associated with the website may comprise data identifying one or more advertiser complaints associated with the website, data identifying a frequency with which one or more user selections of advertisements displayed at the website are discarded due to click fraud, and data indicating a revenue amount associated with one or more user selections of advertisements displayed at the website.

A traffic quality score is calculated for the website, wherein calculating a traffic quality score may comprise calculating a quotient of a frequency with which one or more conversions result from one or more user selections of advertisements displayed at the website and a frequency with which one or more users select the one or more advertisements displayed at the website. According to another embodiment, a traffic quality score is calculated through use of a prediction model, which may comprise an ordinal logistic regression model.

One or more traffic quality tiers may be generated through use of analytics data and traffic quality metric data associated with one or more websites. According to one embodiment, the one or more traffic quality tiers are generated through use of a clustering algorithm, such as a k-means, k-median, two-step, Ward's minimum variance clustering analysis, or single linkage clustering algorithm. According to another embodiment of the invention, the one or more traffic quality tiers are generated through use of equal percentile binning.

The traffic quality tier to which the website belongs may also be identified based upon the analytics data and the traffic quality metric data associated with the website and the one or more traffic quality tiers. According to one embodiment of the invention, a logistic regression analysis is performed upon the analytics data and traffic quality metric data associated with the website and the analytics data and traffic quality metric data associated with the one or more websites comprising the one or more traffic quality tiers.

An adjustment factor is calculated for the website based upon the traffic quality score associated with the website and a benchmark traffic quality score. According to one embodiment of the invention, an adjustment factor is calculated through use of a traffic quality score for the traffic quality tier to which the website belongs, wherein the traffic quality score for the tier may comprise a median traffic quality score or a mean traffic quality score for a given traffic quality tier. The quotient of the traffic quality score associated with the website and the benchmark traffic quality score is calculated, yielding an adjustment factor for the website.

According to one embodiment, the method of the present invention further comprises determining a revenue impact of the adjustment factor associated with the website. Determining the revenue impact of the adjustment factor associated with the website may comprise generating a prediction of an impact on revenue earned by the website or generating a prediction of an impact on a cost to an advertiser that provides the advertisement to the website. The adjustment factor associated with the website may thereafter be modified based upon the determined revenue impact.

The present invention is further directed towards a system for generating a adjustment factor for a cost associated with a user selection of an advertisement displayed at a website. The system of the present invention comprises a traffic quality score component operative to generate a traffic quality score for a website through use of analytics data and traffic quality metric data associated with the website. The traffic quality score component may be further operative to generate one or more traffic quality tiers through use of analytics data and traffic quality metric data associated with one or more websites. According to one embodiment of the present invention, the traffic quality score component generates one or more traffic quality tiers through use of equal percentile binning.

An adjustment factor component is operative to identify a given traffic quality tier to which the website belongs. According to one embodiment, the traffic quality tier to which the website belongs is identified through use of a logistic regression analysis performed upon the analytics data and traffic quality metric data associated with the website and the one or more websites comprising the one or more traffic quality tiers.

The adjustment factor component is further operative to calculate an adjustment factor for the website through use of the traffic quality score associated with the website and a benchmark traffic quality score. According to one embodiment, the adjustment factor component identifies a traffic quality score associated with the traffic quality tier to which the website belongs. The adjustment factor thereafter calculates a quotient of the traffic quality score associated with the given traffic quality tier to which the website belongs and a benchmark traffic quality score. The traffic quality score associated with the traffic quality tier to which the website belongs may comprise a median or mean traffic quality score.

According to one embodiment, the system of the present invention further comprises a revenue impact component operative to determine a revenue impact of the adjustment factor associated with the website. The revenue impact component may determine the revenue impact of the adjustment factor associated with the website through use of a prediction model to predict an impact on revenue earned by the website. Alternatively, or in conjunction with the foregoing, the revenue impact component may generate a prediction of an impact on a cost to an advertiser that provides the advertisement to the website. The revenue impact component may thereafter modify the adjustment factor associated with the website based upon the determined revenue impact of the adjustment factor.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for generating an adjustment factor for a cost associated with a user selection of an advertisement displayed at a given website according to one embodiment of the present invention;

FIG. 2 is a flow diagram presenting a method for generating an adjustment factor for a cost associated with a user selection of an advertisement displayed at a given website according to one embodiment of the present invention;

FIG. 3 is a flow diagram presenting a method for calculating a traffic quality score for a given website according to one embodiment of the present invention;

FIG. 4 is a flow diagram presenting a method for identifying a traffic quality tier to which a given website belongs according to one embodiment of the present invention; and

FIG. 5 is a flow diagram presenting a method for calculating an adjustment factor for a cost associated with a user selection of an advertisement displayed at a given website and determining the revenue impact of the adjustment factor according to one embodiment of the present invention.

### DETAILED DESCRIPTION OF THE PREFERRED EMBODIMENT

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

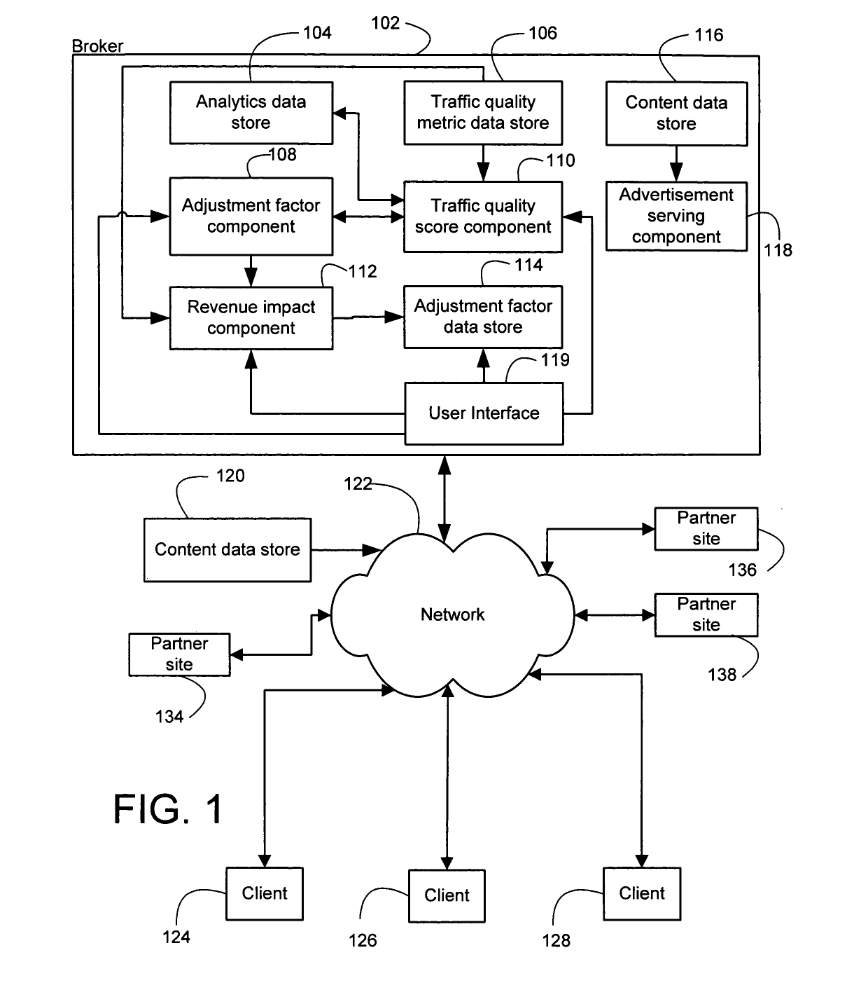

FIG. 1 presents a block diagram depicting one embodiment of a system for generating an adjustment factor for a cost associated with a user selection of an advertisement displayed at a given website based upon the traffic quality of the website. According to the embodiment illustrated in FIG. 1, client devices 124, 126 and 128 are communicatively coupled to a network 122, which may include a connection to one or more local and wide area networks, such as the Internet. According to one embodiment of the invention, a client device 124, 126 and 128 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A user of a client device 124, 126, and 128 communicatively coupled to the network 122 may visit one or more partner sites 134, 136, and 138, wherein a partner site may comprise a website, such as news website, an online shopping website, an auction website, a blog website, etc. A partner site 134, 136, and 138 may display a plurality of content including, but not limited to, one or more advertisements.

The one or more partner sites visited by a user of a client device 124, 126, and 128 may contain data indicating a location to which requests are to be delivered for one or more advertisements to be displayed at the partner site 134, 136, and 138. For example, a given partner site 134, 136, and 138 may contain HTML tags or JavaScript code identifying a location to which requests are to be delivered for one or more advertisements to be displayed at a given partner site 134, 136, and 138. When a given partner site 134, 136, and 138 is visited by a user of a client device 124, 126, and 128, a request may be delivered from the client device 124, 126, and 128 to the location specified by the HTML tags, JavaScript code, etc.

According to one embodiment of the invention, a request for one or more advertisements to be displayed at a given partner site 134, 136, and 138 is delivered to an advertisement serving component 118 at a broker 102. The advertisement serving component 118 at the broker 102 is operative to search one or more local 116 or remote 120 content data stores in order to identify and select one or more advertisements to be displayed at a given partner site 134, 136, and 138. For example, the advertisement serving component 118 may select one or more advertisements from local 116 or remote 120 content data stores based upon the content of the partner site 134, 136, and 138 at which the one or more advertisements are to be displayed, as indicated by the request received from the partner site 134, 136, and 138. Exemplary systems and methods for selecting one or more advertisements to be displayed at one or more partner sites 134, 136, and 138 is described in commonly owned U.S. patent application Ser. No. 11/324,129, entitled “SYSTEM AND METHOD FOR ADVERTISEMENT MANAGEMENT,” filed Dec. 30, 2005, the disclosure of which is hereby incorporated by reference in its entirety.

The one or more advertisements transmitted by the broker 102 for display at a given partner site 134, 136, and 138 may be selected by a user of a client device 124, 126, and 128 through use of a selection device, such as a mouse or a keyboard. Upon selection of a given advertisement displayed at a partner site 134, 136, and 138, a user of a client device 124, 126, and 128 may be redirected to a website associated with the selected advertisement, such as the website of the advertiser associated with the selected advertisement. A user of a client device 124, 126, and 128 may thereafter browse the advertiser's website, purchase one or more products or services available on the advertiser's website, etc.

Information associated with the partner sites 134, 136, and 138 at which advertisements are displayed may be delivered to an analytics data store 104 at the broker 102. The analytics data store 104 is an accessible memory structure such as a database, CD-ROM, tape, digital storage library, etc. The analytics data store 104 is operative to maintain analytics data associated with one or more partner sites 134, 136, and 138, and may be implemented as a database or any other type of data storage structure capable of providing for the retrieval and storage of data for one or partner sites 134, 136, and 138.

The information associated with the partner sites 134, 136, and 138 at which advertisements are displayed that is delivered to the analytics data store 104 may comprise information including, but not limited to, the frequency with which advertisements are selected at a given partner site 134, 136, and 138, and the frequency with which a conversion results from selection of advertisements displayed at a given partner site 134, 136, and 138. For example, a user of a client device 124, 126, and 128 may visit a given partner site 134, 136, and 138, and may select an advertisement transmitted by the broker 102 for display at the partner site 134, 136, and 138, redirecting the user to the advertiser website associated with the selected advertisement. The user may thereafter browse the advertiser website associated with the selected advertisement and purchase a product or service from the advertiser website. Information associated with the user selection of the advertisement displayed at the partner site 134, 136, and 138, as well as information associated with the conversion resulting from the selection of the advertisement displayed at the partner site 134, 136, and 138, may be delivered to the analytics data store 104, in addition to other data.

A traffic quality metric data store 106 may maintain various traffic quality metric data for one or more partner sites 134, 136, and 138. The traffic quality metric data maintained in the traffic quality metric data store 106 may comprise information such as the frequency or number of complaints provided by one or more advertisers with respect to a given partner site 134, 136, and 138, as well as click-through protection metrics (e.g., the frequency with which user selections of advertisements displayed at a given partner site 134, 136, and 138 are discarded due to click-fraud).

The traffic quality metric data maintained in the traffic quality metric data store 106 may further comprise information such as the rate with which one or more users of client devices 124, 126, and 128 visit a given partner site 134, 136, and 138, and the one or more ranks at which a partner site 134, 136, and 138 is displayed in a search results page in response to one or more search requests generated by users of client devices 124, 126, and 128. For example, the traffic quality metric data store 106 may maintain information for a given partner site 134, 136, and 138 identifying the number of complaints received by advertisers disputing the number of user selections of advertisements displayed at the partner site 134, 136, and 138. Similarly, the traffic quality metric data store 106 may maintain information for a given partner site 134, 136, and 138 identifying the average rank at which the partner site 134, 136, and 138 is displayed in a ranked list of partner sites 134, 136, and 138 in response to one or more search queries received by users of client devices 124, 126, and 128.

A traffic quality score component 110 utilizes the information maintained in the analytics data store 104 and the traffic quality metric data store 106 to generate a traffic quality score for one or more partner sites 134, 136, and 138, wherein a traffic quality score comprises a numerical value indicating the quality of the traffic of a given partner site 134, 136, and 138. According to one embodiment of the invention, the traffic quality score component 110 utilizes the frequency with which one or more advertisements were selected in a given partner site 134, 136, and 138, as well as the frequency with one or more conversions resulted from one or more user selections of advertisements displayed at the partner site 134, 136, and 138, to generate a traffic quality score. According to another embodiment of the invention, the traffic quality score component 110 utilizes a prediction model to analyze the traffic quality metric data maintained in the traffic quality metric data store 106, which may include utilization of the analytics data maintained in the analytics data store 104, to generate a traffic quality score for a given partner site 134, 136, and 138, also referred to as an estimated traffic quality score.

The traffic quality score component 110 is further operative to utilize the information maintained in the analytics data store 104 and the traffic quality metric data store 106 to generate one or more traffic quality tiers. According to one embodiment of the invention, the traffic quality score component 110 utilizes a clustering algorithm to analyze the data maintained in the analytics data store 104 and the traffic quality metric data store 106 in order to generate one or more traffic quality tiers. For example, the traffic quality score component 110 may utilize a k-means clustering algorithm or a k-median clustering algorithm to analyze the data maintained in the analytics data store 104 and the traffic quality metric data store 106 to generate one or more traffic quality tiers. Similarly, the traffic quality score component 110 may utilize a binning, k-means, k-median, two-step density linkage, Ward's minimum variance clustering analysis, or single linkage clustering algorithm to analyze the data maintained in the analytics data store 104 and the traffic quality metric data store 106 to generate one or more traffic quality tiers.

According to one embodiment, a given traffic quality tier generated by the traffic quality score component 110 comprises the one or more partner sites 134, 136, and 138 with similar or matching attributes with respect to one or more traffic quality metrics or analytics data. For example, a given traffic quality tier may comprise one or more partner sites 134, 136, and 138 with similar rates with respect to user selections of advertisements (e.g., “click-through rate”) or similar conversion rates, as indicated by the data maintained in the analytics data store 104. Similarly, a given traffic quality tier may comprise one or more partner sites 134, 136, and 138 with traffic quality scores in a given range. Alternatively, or in conjunction with the foregoing, a given traffic quality tier may comprise one or more partner sites 134, 136, and 138 with similar attributes with respect to the one or more traffic quality metrics maintained in the traffic quality metric data store 106 for the one or more partner sites 134, 136, and 138.

The traffic quality tiers generated by the traffic quality score component 110 through use of a clustering or binning algorithm may be continually refined as additional data is received for existing or new partner sites 134, 136, and 138. For example, the traffic quality score component 110 may be operative to generate new or update existing traffic quality tiers after a given period of time, such as every twenty-four hours. Alternatively, or in conjunction with the foregoing, the traffic quality score component 110 may be operative to generate new or update existing traffic quality tiers after a given quantity of analytics data or traffic quality metric data received passes a threshold. For example, the traffic quality score component 110 may generate or update traffic quality tiers when data for one hundred existing or new partner sites 134, 136, and 138 is received.

An adjustment factor component 108 at the broker 102 may utilize the data associated with the one or more traffic quality tiers generated by the traffic quality score component 110 and the data associated with a given partner site 134, 136, and 138 to identify a traffic quality tier to which the partner site 134, 136, and 138 belongs. According to one embodiment of the present invention, the adjustment factor component 108 utilizes a logistic regression analysis to assign a given partner site 134, 136, and 138 to a given traffic quality tier of the one or more traffic quality tiers generated by the traffic quality score component 110.

The adjustment factor component 108 is further operative to calculate an adjustment factor for a given partner site 134, 136, and 138 based upon the traffic quality score associated with the partner site 134, 136, and 138 and a benchmark traffic quality score. According to one embodiment, the benchmark traffic quality score is calculated as a mean traffic quality score for a set of one or more sites. According to one embodiment of the present invention, the adjustment factor component 108 identifies a traffic quality score for the traffic quality tier to which a given partner site 134, 136, and 138 belongs for use as the traffic quality score for the given partner site 134, 136 and 138. The traffic quality score may comprise a median traffic quality score, a mean traffic quality score, etc. The adjustment factor component 108 thereafter calculates the quotient of the traffic quality score for the partner site 134, 136, and 138 and the benchmark traffic quality score to generate an adjustment factor for the partner site 134, 136, and 138.

The adjustment factor calculated for a given partner site 134, 136, and 138 identifies a premium or discount to be applied to a cost associated with a user selection of an advertisement displayed at the partner site 134, 136, and 138. For example, one or more advertisements associated with one or more advertisers may be displayed at a given partner site 134, 136, and 138 by a broker 102. A user selection of a given advertisement displayed at the partner site 134, 136, and 138 may result in the advertiser associated with the selected advertisement incurring a charge of eighty cents (“$0.80”) for the user selection. The adjustment factor calculated for the partner site 134, 136, and 138 may comprise the numerical value 0.95, indicating that the cost incurred by an advertiser for a user selection of an advertisement displayed at the partner site 134, 136, and 138 is to be reduced five percent (“5%”). The product of the adjustment factor (0.95) and the charge associated with a user selection of an advertisement displayed at the partner site ($0.80) may be calculated, yielding a cost of seventy-six cents (“$0.76). Similarly, an adjustment factor calculated for the partner site 134, 136, and 128 may comprise the numerical value 1.15, indicating that the cost incurred by an advertiser for a user selection of an advertisement displayed at the partner site 134, 136, and 138 is to be increased fifteen percent (“%15”), e.g., a premium.

The one or more adjustment factors calculated for one or more partner sites 134, 136, and 138 may be delivered to a revenue impact component 112 at the broker. The revenue impact component 112 is operative to estimate the revenue impact of the adjustment factors for the one or more partner sites 134, 136, and 138 and one or more advertisers that provided the one or more partner sites 134, 136, and 138 with advertisements, which may also include any impact to the broker 102. For example, the revenue impact component 112 may determine the decrease in revenue earned by one or more partner sites 134, 136, and 138 after a discount is provided to one or more advertisers that display advertisements at the one or more partner sites 134, 136, and 138, which may include any revenue impact to the broker 102. Similarly, the revenue impact component 112 may determine the increase in revenue that may be generated by one or more partner sites 134, 136, and 138 after a premium is applied to the cost associated with one or more user selections of advertisements displayed within the partner sites 134, 136, and 138 by one or more advertisers. Alternatively, or in conjunction with the foregoing, the revenue impact component 112 is operative to estimate the impact of the adjustment factors with respect to the cost incurred by one or more advertisers that provide the one or more partner sites 134, 136, and 138 with advertisements.

According to one embodiment of the invention, the revenue impact component 112 utilizes the adjustment factor associated with a given partner site, as well as a traffic acquisition cost associated with the partner site 134, 136, and 138 to determine the revenue impact of the adjustment factor upon the partner site 134, 136, and 138 and an advertiser, an may also include any revenue impact to the broker 102. A traffic acquisition cost may comprise a numerical value, maintained in the traffic quality metric data store 106, indicating a payment amount received by a given partner site 134, 136, and 138 for displaying one or more advertisements at the partner site 134, 136, and 138. According to one embodiment, a traffic acquisition cost comprises a fixed dollar amount received by a partner site 134, 136, and 138 from one or more advertisers for displaying advertisements at the partner site 134, 136, and 138. The revenue impact component 112 is operative to calculate the decrease or increase in revenue that a given partner site 134, 136, and 138 may earn from one or more advertisers for displaying the advertisers' one or more advertisements at the partner site 134, 136, and 138 upon application of the adjustment factor.

According to another embodiment of the invention, the revenue impact component 112 may also determine the decrease or increase in revenue earned by the broker 102 that transmits one or more advertisements to the one or more partner sites 134, 136, and 138 upon implementing the one or more adjustment factors for the one or more partner sites 134, 136, and 138. As previously described, the broker 102 selects and transmits one or more advertisements that are displayed at one or more partner sites 134, 136, and 138. Partner sites 134, 136, and 138 may generate revenue through user selections of advertisements transmitted to the partner sites 134, 136, and 138 by the broker 102. The broker 102 may receive a portion, such as a percentage, of the revenue generated from partner sites 134, 136, and 138 for the one or more user selections of advertisements displayed at the partner sites 134, 136, and 128 by the broker. The revenue impact component 112 is operative to determine the revenue impact upon the broker 102 after the adjustment factors are applied to the one or more partner sites 134, 136, and 138.

The revenue impact component 112 is further operative to predict or otherwise model the way in which a given partner site 134, 136, and 138 may react to an adjustment factor applied to the partner site 134, 136, and 138. According to one embodiment of the invention, the revenue impact component 112 is operative to utilize data associated with one or more partner sites 134, 136, and 138 or one or more advertisers, which may be maintained in the analytics data 104 store or traffic quality metric data store 106, to determine the way in which partner sites 134, 136, and 138 and advertisers may react in response to the one or more adjustment factors. The revenue impact component 112 may utilize data, such as the budget of one or more advertisers, to model or predict the way in which advertisers may be affected by an adjustment factor associated with a given partner site 134, 136, and 138. For example, a premium adjustment factor may be applied to a given partner site 134, 136, and 138 that displays advertisements from a given advertiser with a limited budget. The premium adjustment factor may result in the cost associated with a user selection of one or more advertisements associated with the advertiser exceeding the advertiser's available budget, thereby resulting in the advertiser choosing to display advertisements in one or more alternate partner sites 134, 136, and 138.

Alternatively, or in conjunction with the foregoing, the revenue impact component 112 may utilize information identifying the quantity, such as the percentage, of advertisements provided by the broker 102 to a given partner site 134, 136, and 138 in order to predict or model the way in which a given partner site 134, 136, and 138 may react in response to an adjustment factor applied to one or more user selections of advertisements displayed at the partner site 134, 136, and 138. For example, a small discount adjustment factor applied to a given partner site 134, 136, and 138 that receives a small percentage of advertisements from the broker 102 may have less of an impact upon the partner site's revenue, and therefore, may be less likely to result in an adverse partner site reaction, such as the partner site 134, 136, and 138 choosing to receive advertisements from an alternate broker 102. Similarly, a large discount adjustment factor applied to a given partner site 134, 136, and 138 that receives a large percentage of advertisements from the broker 102 may have a larger impact upon the revenue of the partner site, and thus may be more likely to result in an adverse partner site 134, 136, and 138 reaction.

Based upon the prediction or model of the way in which a given partner site 134, 136, and 138 or advertiser may react in response to an adjustment factor, as well as the revenue impact of the adjustment factors upon partner sites 134, 136, and 138 and the broker 102, the revenue impact component 112 may modify the one or more adjustment factors associated with one or more partner sites 134, 136, and 138. For example, the revenue impact component 112 may determine that one or more adjustment factors may result in a significant loss of revenue for one or more partner sites 134, 136, and 138 and/or the broker 102. Therefore, the revenue impact component 112 may modify the adjustment factors in order to reduce or minimize the revenue impact upon the partner sites 134, 136, and 138 and the broker 102.

Similarly, the revenue impact component 112 may determine that a given partner site 134, 136, and 138 is required to receive a minimum dollar amount for each user selection of an advertisement displayed at the partner site 134, 136, and 138. The revenue impact component 112 may thus modify the adjustment factor for the partner site to ensure that the partner site 134, 136, and 138 continues to receive at least the minimum dollar amount for each user selection of an advertisement displayed at the partner site 134, 136, and 138.

The one or more adjustment factors generated for the one or more partner sites 134, 136, and 138 may thereafter be delivered to an adjustment factor data store 114. The adjustment factor data store 114 is an accessible memory structure such as a database, CD-ROM, tape, digital storage library, etc. The adjustment factor data store 114 is operative to maintain adjustment factors associated with one or more partner sites 134, 136, and 138, and may be implemented as a database or any other type of data storage structure capable of providing for the retrieval and storage of adjustment factors for one or more partner sites.

A user interface 119 at the broker 102 may be used to apply one or more human overrides to the one or more adjustment factors associated with one or more partner sites 134, 136, and 138. According to one embodiment of the invention, a human override, such as an increase or decrease, may be applied to the one or more adjustment factors delivered to and maintained in the adjustment factor data store 114 for one or more partner sites 134, 136, and 138. For example, a human review of the adjustment factors associated with one or more partner sites 134, 136, and 138 may performed through use of the user interface 119 at the broker, resulting in the modification of one or more adjustment factors for one or more partner sites 134, 136, and 138.

Alternatively, or in conjunction with the foregoing, the traffic quality scores, traffic quality tiers, and revenue impact information by which adjustment factors are generated for one or more partner sites 134, 136, and 138 may be modified through use of the user interface 119 at the broker. For example, a human accessing the broker 102 via the user interface 119 may choose to modify the traffic quality score generated for a given partner site 134, 136, and 138 by the traffic quality score component or the traffic quality tier to which the partner site 134, 136, and 138 is assigned. Similarly, a human accessing the broker 102 via the user interface may choose to increase or decrease the revenue impact associated with a given adjustment factor generated for a given partner site 134, 136, and 138, which may result in one or more modifications to the adjustment factor associated with the partner site 134, 136, and 138.

The adjustment factors maintained in the adjustment factor data store 114 may be used to determine an advertiser's cost for one or more user selections of advertisements displayed at one or more partner sites 134, 136, and 138. Alternatively, or in conjunction with the foregoing, the adjustment factors maintained in the adjustment factor data store 114 may be used in a bidding marketplace to modify bids provided by one or more advertisers to display advertisements at a given partner site 134, 136, and 138. For example, in a bidding marketplace, one or more advertisers may provide bids to have advertisements displayed at a given partner site 134, 136, and 138. The bids provided by one or more advertisers for a given partner site 134, 136, and 138 may be modified according to the adjustment factor associated with the partner site 134, 136. Additionally, it should be noted that adjustment factors may be made at different levels. One exemplary level is the combination of a partner site 134, 136 and 138 and a specific advertisement. Other exemplary levels include combinations of a partner web site, or a group of advertisements and a given advertiser.

Those of skill in the art recognize that the system illustrated in FIG. 1 is not limited to calculating adjustment factors with respect to user selections of advertisements displayed at one or more partner sites 134, 136, and 138 and may be used to calculate adjustment factors for partner sites 134, 136, and 138 with respect to one or more advertising metrics. For example, the system illustrated in FIG. 1 may be used to calculate adjustment factors for one or more partner sites 134, 136, and 138, wherein the adjustment factors may be applied to the cost associated with displaying advertisements (“impressions”) at the one or more partner sites 134, 136, and 138 based upon the traffic quality associated with the one or more partner sites 134, 136, and 138.

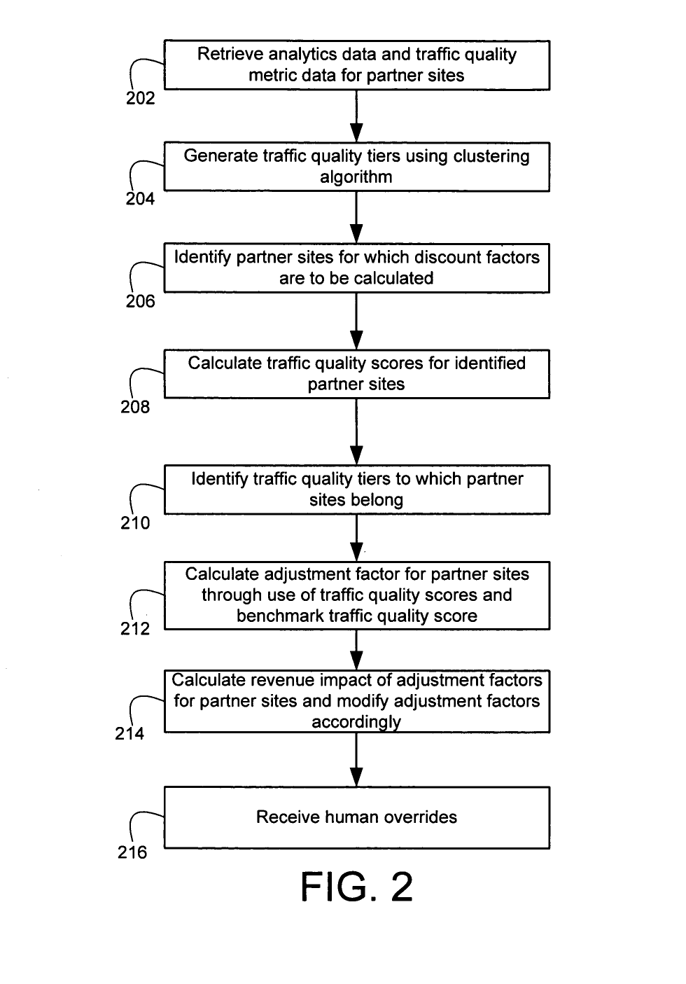

FIG. 2 is a flow diagram presenting a method for generating an adjustment factor for one or more partner sites based upon the traffic quality associated with the one or more partner sites. According to one embodiment of the invention, a partner site comprises a website that displays one or more advertisements supplied to the partner site by a broker. As illustrated in FIG. 2, analytics data is retrieved for one or more partner sites, step 202. The analytics data retrieved for a given partner site may comprise the frequency with which one or more advertisements displayed at the partner site were selected, as well as the frequency with which one or more conversions resulted from the selection of one or more advertisements displayed at the partner site. The traffic quality metric data retrieved for a given partner site may comprise data including, but not limited to, one or more advertiser complaints associated with a given partner site, as well as click-through protection metrics identifying the frequency with which user selections of advertisements displayed at a given partner site are discarded due to click-fraud. The traffic quality metric data may further comprise data indicating a given partner site's rank within a ranked list of partner sites in response to one or more search queries, the revenue earned by the partner site, or the frequency with which one or more users of client devices access the partner site.

The analytics data and traffic quality metric data retrieved for one or more partner sites may be used to generate traffic quality tiers, wherein a traffic quality tier comprises one or more partner sites with common characteristics or attributes as determined by a given clustering algorithm, step 204. For example, the one or more traffic quality tiers may comprise one or more groups of partner sites with similar revenue amounts and click-through rates as determined by a k-means or k-median clustering algorithm. Similarly, the one or more traffic quality tiers may comprise one or more groups of partner sites with similar conversion rates as determined by a binning or a two-step density linkage, a Ward's minimum variance clustering analysis, or a single linkage clustering algorithm.

One or more partner sites are selected for which adjustment factors are to be calculated, step 206. A traffic quality score is thereafter calculated for the one or more selected partner sites, step 208. The traffic quality scores may be calculated through use of the analytics data associated with the one or more partner sites, as well as the traffic quality metric data associated with the one or more partner sites. For example, a traffic quality score for a given partner site may be calculated using the frequency with which one or more advertisements are selected at the partner site and the frequency with which one or more conversions resulted from the one or more user selections of advertisements displayed at the partner site. Alternatively, or in conjunction with the foregoing, a traffic quality score may be calculated for a given partner site through use of the traffic quality metric data associated with the partner site, indicating the number of advertiser complaints associated with the partner site, the revenue of the partner site, the frequency with which users access the partner site, etc.

The traffic quality tiers to which the one or more selected partner sites belong are identified, step 210. According to one embodiment of the invention, a logistic regression analysis is performed to identify the traffic quality tier to which a given partner site belongs. For example, an ordinal logistic regression analysis may be performed upon the data associated with the one or more partner sites comprising the one or more traffic quality tiers, as well as the data associated with a given partner site in order to identify a traffic quality tier to which the given partner sites belongs.

An adjustment factor is thereafter calculated for the one or more partner sites through use of the traffic quality scores associated with the one or more partner sites and a benchmark traffic quality score, step 212. According to one embodiment of the invention, a traffic quality score associated with a given traffic quality tier is calculated that may comprise the average or mean traffic quality score of the one or more partner sites within the traffic quality tier. A traffic quality score associated with a given traffic quality tier comprises the median traffic quality score associated with the one or more partner sites within the traffic quality tier. Those of skill in the art recognize the plurality of techniques that may be used to identify a traffic quality score for a given traffic quality tier.

The traffic quality scores associated with the one or more selected partner sites and the benchmark traffic quality score is used to calculate an adjustment factor for the one or more partner sites. Alternatively, the traffic quality scores associated with the one or more traffic quality tiers to which the one or more selected partner sites belong are used in place of the traffic quality score for a given partner site. According to one embodiment of the invention, the adjustment factor for a given partner site comprises the quotient of the traffic quality score and the benchmark traffic quality score.

The revenue impact of the adjustment factors calculated for the one or more partner sites is thereafter determined according to methods described herein, step 214. The revenue impact associated with a given adjustment factor for a given partner site may be used to modify the adjustment factor. For example, a discount adjustment factor resulting in a significant decrease in revenue for a given partner site, the broker from which the partner site receives advertisements, or the advertiser providing the partner site with advertisements may be modified in order to reduce or minimize a decrease in revenue. Similarly, a premium discount factor applied to a given partner site resulting in a significant increase in cost for one or more advertisers with a limited budget that display advertisements at the partner site may be modified in order to reduce the increase in cost.

According to the embodiment illustrated in FIG. 2, one or more human overrides to the one or more adjustment factors calculated for the one or more partners may be received, step 216. According to one embodiment of the invention, a human override of an adjustment factor comprises a modification, such as an increase or a decrease, of the adjustment factor. For example, a given partner site may be associated with an adjustment factor of 1.25, indicating that the cost associated with one or more user selections of advertisements displayed within the partner site are to be charged a 25% premium. A human may choose to decrease the adjustment factor associated with the partner site to 1.15, thereby decreasing the amount of the premium associated with a user selection of an advertisement displayed within the partner site to %15.

According to another embodiment of the invention, a human override may be received at one or more of the steps illustrated in FIG. 2. For example, a human may choose to increase or decrease the traffic quality scores generated for one or more partner sites at step 208. Similarly, a human may choose to modify the traffic quality tier to which one or more partner sites are assigned, as determined at step 210.

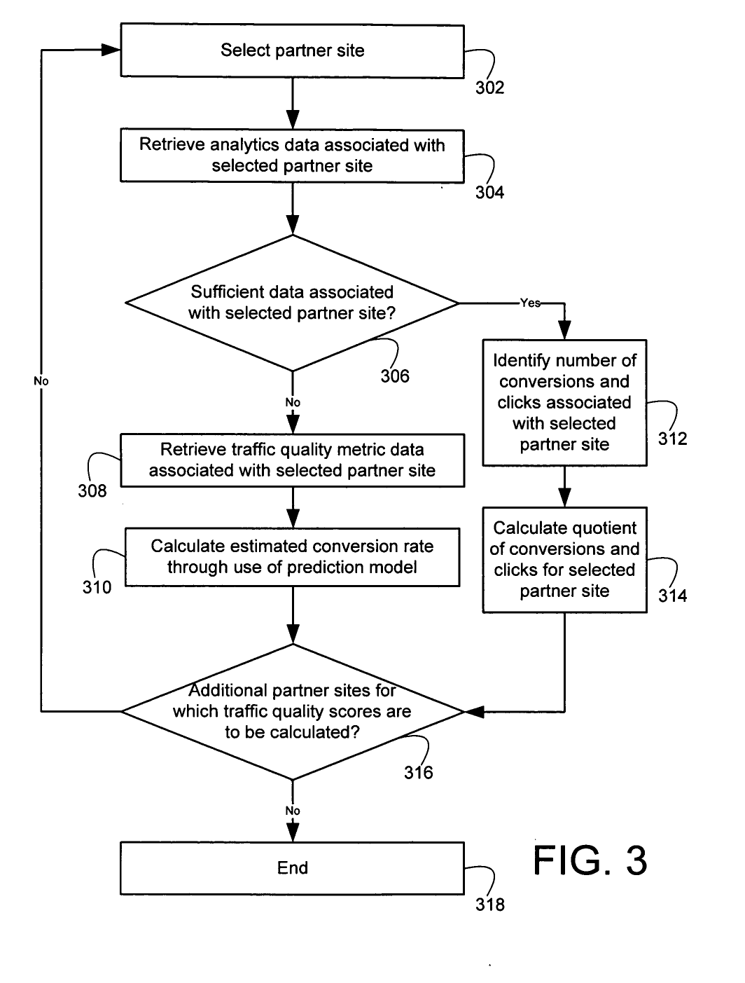

FIG. 3 is a flow diagram presenting a method for calculating a traffic quality score for a given partner site through use of the analytics data or traffic quality metric data associated with the partner site. According to the embodiment illustrated in FIG. 3, a given partner site is selected from among one or more partner sites for which a traffic quality score is to be calculated, step 302, and analytics data associated with the selected partner site is retrieved, step 304. As previously described, the analytics data associated with a given partner site may comprise data including, but not limited to, the frequency with which one or more advertisements displayed at the partner site were selected by one or more users of client devices, and the frequency with which one or more user selections of advertisements displayed at the partner site resulted in the purchase of a product or service from the advertiser website associated with a selected advertisement (e.g., “conversions”).

A check is performed to determine whether the selected partner site is associated with a sufficient quantity of analytics data, step 306. According to one embodiment of the invention, the check performed at step 306 comprises a determination as to whether the selected partner site is associated with a sufficient quantity of user selection data regarding advertisements displayed at the partner site. According to another embodiment of the invention, the check performed at step 306 comprises a determination as to whether the selected partner site is associated with a sufficient quantity of conversion data resulting from user selections of advertisements displayed at the partner site.

If the selected partner site is associated with a sufficient quantity of analytics data, the number of user selections of advertisements displayed at the partner site, as well as the number of conversions resulting from user selections of advertisements displayed at the partner site, are identified, step 312. The quotient of the identified number of conversions and number of user selections is calculated, yielding a conversion rate for the selected partner site, which comprises a traffic quality score for the partner site, indicating the relative quality of the user traffic associated with the partner site, step 314.

If the selected partner site is not associated with a sufficient quantity of analytics data, step 306, the traffic quality metric data associated with the selected partner site is retrieved, step 308. As previously described, the traffic quality metric data associated with a given partner site may comprise data including, but not limited to, the number of complaints provided by one or more advertisers with respect to the partner site, click-through protection metrics, such as the frequency with which user selections of advertisements displayed at a given partner site are discarded, or the rate at which users of client devices visit the partner site. The traffic quality metric data associated with a given partner site may further comprise the average rank at which the partner site is displayed in a ranked list of partner sites in response to one or more search queries, the revenue generated by the partner site, or the rate at which advertisements are displayed at the partner site (“impressions”).

The traffic quality metric data retrieved for the selected partner site may be used by a prediction model to generate an estimated conversion rate for the selected partner site, which comprises the partner site's traffic quality score, step 310. According to one embodiment of the invention, the prediction model used to generate an estimated conversion rate for a given partner site comprises an ordinal logistic regression model used to analyze the traffic quality metric data associated with the partner site.

A check is thereafter performed to determine whether traffic quality scores are to be generated for one or more one or more additional partner sites, step 316. If traffic quality scores are to be generated for one or more additional partner sites, a next partner site is selected from among the one or more partner sites, step 302. After traffic quality scores have been generated for the one or more partner sites, processing terminates, step 318.

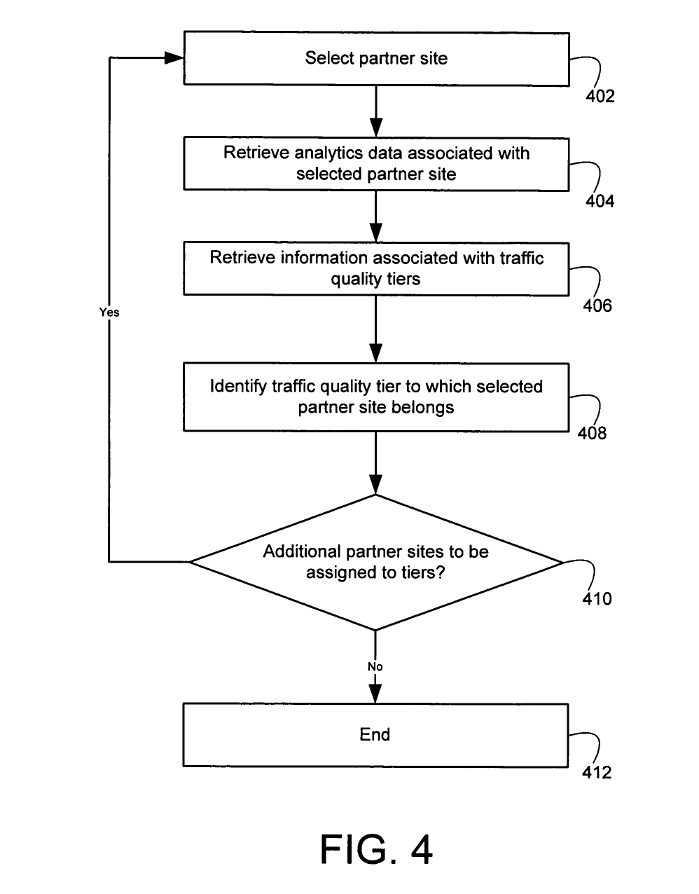

FIG. 4 is a flow diagram illustrating one embodiment of a method for identifying a traffic quality tier to which a given partner site belongs. According to the embodiment illustrated in FIG. 4, a given partner site is selected from among one or more partner sites for assignment to a traffic quality tier, step 402. Analytics data and traffic quality metric data associated with the selected partner site are retrieved, step 404. The analytics data associated with the selected partner site may comprise data indicating a frequency with which one or more users selected one or more advertisements displayed at the partner site, as well as the frequency with which conversions resulted from the user selections of the one or more advertisements. The traffic quality metric data associated with the selected partner site may comprise click-through-protection data, revenue data, the number of advertiser complaints associated with the partner site, and the frequency with which users of client devices visit the partner site.

Data associated with one or more traffic quality tiers, generated according to methods described herein, is retrieved, step 406. The data retrieved with respect to a given traffic quality tier may comprise the conversion rates and click-through-rates of the one or more partner sites comprising the traffic quality tier, as well as traffic quality metric data associated with the one or more partner sites comprising the traffic quality tier, such as click-through-protection information, frequency of advertiser complaints, etc.

An analysis is performed upon the analytics data and traffic quality metric data associated with the selected partner site, as well as the analytics data and traffic quality metric data associated with the one or traffic quality tiers in order to identify the traffic quality tier to which the selected partner site belongs, step 408. According to one embodiment of the present invention, an ordinal logistic regression model is used to perform an analysis of the analytics data and traffic quality metric data associated with the selected partner site and the one or more traffic quality tiers. For example, the ordinal logistic regression model may analyze the analytics data and traffic quality metric data associated with a given partner site ‘X’ with respect to the analytics data and traffic quality metric data associated with the one or more partner sites comprising traffic quality tiers ‘A,’ ‘B,’ and ‘C.’ The ordinal logistic regression model may determine that the analytics data and traffic quality metric data associated with partner site ‘X’ can be classified in a statistically significant way to the analytics data and traffic quality metric data associated with the one or more partner sites comprising traffic quality tier ‘B.’ Partner site ‘X’ may thereafter be assigned to traffic quality tier ‘B,’ based upon the ordinal logistic regression model analysis.

A check is thereafter performed to determine whether one or more additional partner sites are to be assigned to traffic quality tiers, step 412. If one or more additional partner sites are to be assigned to traffic quality tiers, a next partner site is selected from among the one or more partner sites, step 402. If the one or more partner sites have been assigned to traffic quality tiers, processing terminates, step 412.

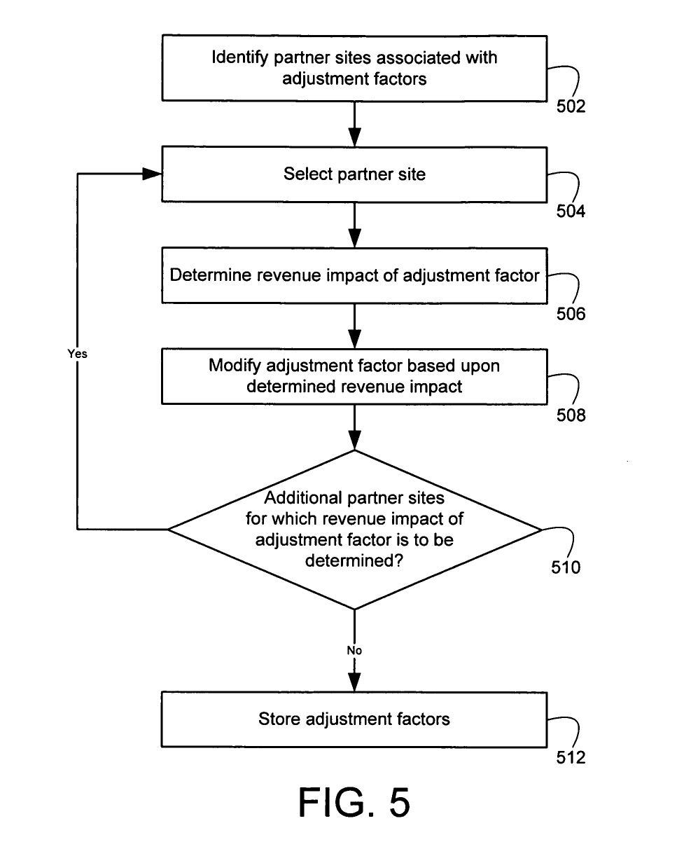

FIG. 5 is a flow diagram illustrating one embodiment of a method for determining the revenue impact of the adjustment factors associated with one or more partner sites. According to the embodiment illustrated in FIG. 5, one or more partner sites for which adjustment factors have been calculated are identified, step 502. A given partner site is selected from among the one or identified partner sites, step 504, and the revenue impact of the adjustment factor associated with the selected partner site is determined, step 506.

According to one embodiment of the invention, determining the revenue impact of an adjustment factor comprises determining the revenue impact of an adjustment factor upon a given partner site. The revenue impact of an adjustment factor upon a given partner site may be determined through use of data indicating the payments received by the partner site from one or more advertisers for one or more user selections of advertisements displayed at the partner site. For example, a given partner site may receive twenty cents (“$0.20”) from one or more advertisers for each user selection of an advertisement displayed at the partner site. Additionally, the partner site may receive an average of one thousand (“1,000”) user selections of advertisements in a given time period, such as every twenty-four (“24”) hours, resulting in the partner generating revenue of two hundred dollars (“$200”). The adjustment factor calculated for the partner site may comprise the numerical value 0.85, indicating that a user selection of an advertisement displayed at the partner site is to be reduced or discounted fifteen percent (“15%”). Application of the adjustment factor to the partner site will therefore result in the partner site receiving 15% less revenue, or $185, resulting in a loss of revenue of $15.

Determining the revenue impact of an adjustment factor upon a partner site may also comprise determining whether an adjustment factor may result in increased or decreased advertiser spending, and therefore increased or decreased revenue for a given partner site. According to one embodiment of the invention, a prediction model is used to determine the potential reaction of one or more advertisers in response to an adjustment factor for a given partner site. For example, a prediction model may be used to determine that a discount adjustment factor associated with a given partner site will entice one or more advertisers to display advertisements at the partner site, thus resulting in a possible increase in revenue for the partner site. Similarly, a prediction model may be used to determine that a premium adjustment factor associated with a given partner site may result in one or more advertisers choosing to display advertisements at one or more alternative partner sites.

According to another embodiment of the invention, the revenue impact of the adjustment factor associated the partner site is determined with respect to the broker that provides the partner site with advertisements. For example, a broker may select and transmit advertisements to be displayed at a given partner site. The broker may receive a percentage of the revenue generated by the partner site from the one or more advertisers associated with the advertisements displayed at the partner site. The revenue impact upon the broker may be determined utilizing the data indicating the revenue generated by the partner site to which the broker delivers advertisements, as well the data indicating the percentage of revenue received by the broker from the partner site.

Determining the revenue impact of an adjustment factor upon a broker site may also comprise utilizing a prediction model to predict the way in which a partner site will react in response to an adjustment factor. For example, a prediction model may determine that a discount adjustment factor applied to a partner site that receives a significant quantity of advertisements from the broker may be likely to result in the advertiser choosing to receive advertisements from an alternate broker, resulting in decreased revenue for the broker. Similarly, a prediction model may determine that a discount adjustment factor applied to a partner site may result in additional advertisers choosing to display advertisements at the partner site, resulting in increased revenue for the partner site, and thereby resulting in increased revenue for the broker. Additionally, a prediction model may determine that a premium adjustment factor applied to a partner site may result in increased revenue for the partner site, thereby resulting in increased revenue for the broker.

The adjustment factor is thereafter modified based upon the determined revenue impact, step 508. For example, the adjustment factor associated with the selected partner site may be decreased or increased in order to ensure that the partner site continues to receive a given revenue amount. Similarly, the adjustment factor associated with the selected partner site may be decreased or increased in order to minimize the likelihood that the broker that provides the partner site with advertisements receives less revenue.

A check is thereafter performed to determine whether the revenue impact of an adjustment factor is to be determined for one or more partner sites for which an adjustment factor has been calculated, step 510. If additional partner sites require analysis, a next partner site is selected, step 502. After the revenue impact of the adjustment factors associated with the one or more partner sites have been determined, the one or more adjustment factors are stored, such as in a database or similar storage structure, step 512. The adjustment factors may be used to determine the cost associated with one or more user selections of advertisements displayed at one or more partner sites. Alternatively, or in conjunction with the foregoing, the stored adjustment factors may be used in a bidding marketplace to modify one or more bids provided by one or more advertisers for displaying advertisements at one or more partner sites.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for generating a discount factor for a cost associated with a user selection of an advertisement displayed at a website, the method comprising:
retrieving analytics data and traffic quality metric data associated with the website;
calculating a traffic quality score for the website on the basis of the analytics data and the traffic quality metric data; and
calculating an adjustment factor for the website based upon the traffic quality score associated with the website and a benchmark traffic quality score.

2. The method of claim 1 wherein retrieving analytics data for the website comprises retrieving data indicating a frequency with which one or more advertisements displayed at the website are selected.

3. The method of claim 1 wherein retrieving analytics data for the website comprises retrieving data indicating a frequency with which one or more conversions result from one or more user selections of advertisements displayed at the website.

4. The method of claim 1 wherein retrieving traffic quality metric data for the website comprises retrieving data indicating a frequency with which one or more users visit the website.

5. The method of claim 1 wherein retrieving traffic quality metric data for the website comprises retrieving data identifying one or more advertiser complaints associated with the website.

6. The method of claim 1 wherein retrieving traffic quality metric data for the website comprises retrieving data identifying a frequency with which one or more user selections of advertisements displayed at the website are discarded due to click fraud.

7. The method of claim 1 wherein retrieving traffic quality metric data for the website comprises retrieving data indicating a revenue amount associated with one or more user selections of advertisements displayed at the website.

8. The method of claim 1 wherein calculating the traffic quality score comprises calculating a quotient of a frequency with which one or more conversions result from one or more user selections of advertisements displayed at the website and a frequency with which one or more users select the one or more advertisements displayed at the website.

9. The method of claim 1 wherein calculating the traffic quality score comprises utilizing a prediction model.

10. The method of claim 9 wherein a prediction model comprises a logistic regression model.

11. The method of claim 1 wherein calculating the traffic quality score comprises:
generating one or more traffic quality tiers through use of analytics data and traffic quality metric data associated with one or more websites;
identifying a given traffic quality tier to which the website belongs on the basis of the analytics data and the traffic quality metric data associated with the website and the one or more traffic quality tiers; and
setting the traffic quality score of the website to the traffic quality score of the tier.

12. The method of claim 11 wherein generating the one or more traffic quality tiers comprises utilizing a clustering algorithm to generate one or more traffic quality tiers.

13. The method of claim 12 wherein the clustering algorithm is selected from a group consisting of percentile binning, a two-step density linkage, Ward's minimum variance clustering analysis, or single linkage clustering algorithms.

14. The method of claim 11 wherein identifying the given traffic quality tier comprises performing a logistic regression analysis upon the analytics data and traffic quality metric data associated with the website and the analytics data and traffic quality metric data associated with the one or more websites comprising the one or more traffic quality tiers.

15. The method of claim 1 wherein calculating the discount factor for the website comprises:
calculating a quotient of the traffic quality score associated with the website and the benchmark traffic quality score.

16. The method of claim 1 wherein a benchmark traffic quality score comprises a median traffic quality score.

17. The method of claim 1 wherein a benchmark traffic quality score comprises a mean traffic quality score.

18. The method of claim 1 wherein a benchmark traffic quality score comprises a mean traffic quality score of a selected set of websites.

19. (canceled)

20. The method of claim 1 comprising determining a revenue impact of the adjustment factor associated with the website.

21. The method of claim 20 wherein determining the revenue impact of the adjustment factor associated with the website comprises generating a prediction of an impact on revenue earned by the website.

22. (canceled)

23. (canceled)

24. The method of claim 20 comprising modifying the adjustment factor associated with the website based upon the determined revenue impact of the discount factor.

25. A system for generating a discount factor for a cost associated with a user selection of an advertisement displayed at a website, the system comprising:
a traffic quality score component operative to generate a traffic quality score for a website through use of analytics data and traffic quality metric data associated with the website; and
a discount factor component operative to calculate a discount factor for the website through use of the traffic quality score associated with the website and a benchmark traffic quality score.

26. The system of claim 25 wherein the traffic quality score component is operative to:
retrieve analytics data and traffic quality metric data for the website; and generate a traffic quality score for the website through use of the analytics data and traffic quality metric data.

27. The system of claim 25 wherein the traffic quality score component is operative to utilize a clustering algorithm to generate one or more traffic quality tiers.

28. (canceled)

29. The system of claim 25 wherein the discount factor component is operative to perform a logistic regression analysis of the analytics data and traffic quality metric data associated with the website and the one or more websites comprising the one or more traffic quality tiers in order to identify a given traffic quality tier to which the website belongs.

30. (canceled)

31. (canceled)

32. (canceled)

33. (canceled)

34. (canceled)

35. (canceled)

36. (canceled)
